(19) United States
(12) Patent Application Publication
(10) Pub. No.: US 2025/0021086 A1
(43) Pub. Date: Jan. 16, 2025

(54) VISION-BASED ENHANCED OMNI-DIRECTIONAL DEFECT DETECTION APPARATUS AND METHOD

(71) Applicant: SCHOOL OF INFORMATION AND INTELLIGENT ENGINEERING, ZHEJIANG WANLI UNIVERSITY, Ningbo (CN)

(72) Inventors: Weipeng LI, Ningbo (CN); Wen LIU, Ningbo (CN); Chao CHEN, Ningbo (CN); Xiang YAN, Ningbo (CN); Jinwei LIAO, Ningbo (CN); Yi QIAO, Ningbo (CN); Xu CHEN, Ningbo (CN)

(73) Assignee: SCHOOL OF INFORMATION AND INTELLIGENT ENGINEERING, ZHEJIANG WANLI UNIVERSITY, Ningbo (CN)

(21) Appl. No.: 18/536,272

(22) Filed: Dec. 12, 2023

(30) Foreign Application Priority Data
Jul. 11, 2023 (CN) 202310845281X

(51) Int. Cl. G05B 19/418; G06T 7/00; G06T 7/11; G06V 10/44

(52) U.S. Cl. CPC G05B 19/41875; G06T 7/0004; G06T 7/11; G06V 10/44

(57) ABSTRACT

A vision-based enhanced omni-directional defect detection method is provided. The method includes: performing posture adjustment on equipment, changing an equipment angle and a transmission speed, acquiring a multi-angle detection picture, and performing information fusion and classification. By means of the method, the influence of natural and human factors is solved, the problem of missing detection is solved by adoption of defect feature enhancement, and the part detection accuracy is improved.

### CROSS-REFERENCE TO THE RELATED APPLICATIONS

This application is based upon and claims priority to Chinese Patent Application No. 202310845281.X, filed on Jul. 11, 2023, the entire contents of which are incorporated herein by reference.

### TECHNICAL FIELD

The present disclosure relates to the field of machine detection, in particular to a vision-based enhanced omni-directional defect detection apparatus and method.

### BACKGROUND

In the machining and production of industrial parts, the detection of part quality is one of the indispensable links. Currently, defect detection for parts, especially for complex curved surface products, has the following problems: as manual detection is mostly adopted, the cost is high and the efficiency is low; the identification degree of weak defects is low, and weak defects are greatly affected by ambient factors such as light, so the accuracy is low; and due to the randomness of defect distribution, some positions may not be identified in the case of fixed perspective detection, and in the case of manual detection, not only is missing detection prone to occurring, but also secondary defects may be formed on part surfaces.

### SUMMARY

Based on this, in order to solve the problems, the present disclosure provides a vision-based enhanced omni-directional defect detection apparatus and method. The specific technical solutions are as follows:

A vision-based enhanced omni-directional defect detection apparatus includes a conveyor belt, the conveyor belt is connected to a motor and a gearbox, a lift lever is disposed on the conveyor belt opposite to one side where the motor is disposed, the lift lever is provided with a six-degree-of-freedom mechanism and a complementary metal oxide semiconductor (CMOS) camera, a plurality of LED lights are disposed along a longitudinal movement direction of the conveyor belt, a pressure sensor is disposed on the conveyor belt opposite to a surface where the LED lights are disposed, and the pressure sensor is connected to a speed regulator.

The present disclosure provides an online defect detection apparatus that may be used on a production line to achieve multi-feature defect identification through a multi-degree-of-freedom mechanism capable of adjusting the camera as well as the light source, and the apparatus may be used for surface defect identification of complex curved parts.

Further, the CMOS camera is disposed at an extended portion of the lift lever.

Further, six LED lights in total are provided, and the LED lights are equally distributed longitudinally on two sides of the conveyor belt.

Further, the CMOS camera is connected to a tail end of the six-degree-of-freedom mechanism.

Further, a single-chip microcontroller is connected between the pressure sensor and the motor.

A vision-based enhanced omni-directional defect detection method is provided. The entire detection is mainly divided into three major steps: firstly, a source of a suspected defect is searched for, and preliminary identification is performed; then, a posture is adjusted to focus on the detection of the suspected defect, some defect information is incomplete in a single angle, and the purpose of feature enhancement may be achieved in multiple angles; and finally, multiple features are extracted and fused to achieve accurate classification. The method specifically includes:
step 1, performing posture adjustment on equipment, and changing an equipment angle and a transmission speed; step 2, searching for a source of a suspected defect and performing focus detection, that is, collecting information of a multi-angle detection picture, preliminarily identifying the detection picture by using a YOLOv5 defect fast identification technology, and in a case where a confidence value is less than 0.6, continuously sending a signal to change the equipment angle and acquiring the detection picture; step 3, after the multi-angle detection picture is acquired, segmenting a defective region within an identification box in the multi-angle detection picture by using a grayscale threshold, and for the defective region, extracting feature information of a defect in the defective region on the basis of OpenCV, the feature information including area, perimeter, a pixel mean value, and pixel variance information; step 4, extracting a light value of the detection picture on the basis of OpenCV, increasing a brightness difference by actively adjusting the intensity of a light source, and enhancing a contrast between the defect and a background in the detection picture, wherein extraction of the light value includes: converting the detection picture from a red-green-blue (RGB) color space to a hue-saturation-value (HSV) space, extracting brightness V values and calculating a mean value of the brightness V values, and wherein the detection picture has n non-zero pixels, with a non-zero pixels inside the identification box and b non-zero pixels outside the box, HSV values of the non-zero pixels are (h₁, s₁, v₁) (h₂, s₂, v₂), . . . , (hₙ, sₙ, vₙ) respectively, and a pixel mean V value is calculated as:

$$\overline{v} = \frac{1}{n} \text{?} {v}_{i} ,$$

$$\text{?} \text{indicates text missing or illegible when filed}$$

where v̅ₐ and v̅_{b} are brightness mean values inside the identification box and outside the identification box respectively, and a difference is dₘₐₓ=|v̅ₐ−v̅_{b}|.
step 5, performing accurate identification on the defective region, wherein the defect in the defective region is extracted on the basis of OpenCV, data preprocessing is performed firstly, and the image quality is improved through a normalization operation, a normalization formula being

$${x}_{norm} = \frac{x - {x}_{min}}{{x}_{max} - {x}_{min}} ,$$

where X denotes a pixel value of an input image, Xₙₒᵣₘ denotes a pixel value of an output image, Xₘₐₓ denotes a maximum pixel value of the input image, Xₘᵢₙ denotes a minimum pixel value of the input image, and image pixels are adjusted to a range of [0, 1] after normalization;
a defect contour is detected by using Canny edges, then geometric area information S of the defect is acquired by using a function of cv2.contourArea( ) in an OpenCV library, at the same time, geometric perimeter information L of the defect is extracted by using a function of cv2.arcLength( ) in the OpenCV library, a slenderness ratio M and an area occupancy degree N of the defective region are acquired,
the slenderness ratio is obtained by

$$M = \frac{w}{h} ,$$

where h and w are a length value and a width value of the defective rectangular region, and
the area occupancy degree is obtained by

$$N = \frac{S}{w \times h} ;$$

and
step 6, acquiring, on the basis of the multi-feature information of the detection picture, multi-feature average data of the defect, using the multi-feature average data as input, and achieving defect category differentiation through a decision tree classification model.

Further, the collecting information of a multi-angle detection picture includes: changing an angle of a camera by changing a six-degree-of-freedom mechanism, so as to collect detection picture information at different angles.

Further, when the confidence value is less than 0.6, a single-chip microcontroller manipulates a steering gear to adjust the angle of the camera so as to collect the detection picture, and at the same time, in a case where the identification box is present, a plurality of detection pictures are output.

Further, average data of a detection picture dataset includes an area mean value S̅, a perimeter mean value L̅, a slenderness ratio mean value M̅, and an area occupancy degree mean value N̅.

The present disclosure provides an online defect detection method that may be used on a production line to achieve fast source searching and feature identification through posture adjustment, fusion and multi-view light enhancement by a multi-degree-of-freedom mechanism, and the method may be used for surface defect identification of complex curved parts. For defect detection, manual detection is replaced with contactless detection, so that the costs are reduced, and the production efficiency is improved. On the basis of posture adjustment of the camera on the multi-degree-of-freedom mechanism and the YOLOv5 target detection algorithm, rapid positioning of the defect source and omni-directional focus detection are achieved, the problem of insufficient defect information in a single viewpoint is solved, and the detection accuracy is improved. By means of the multi-direction controllable and brightness-adjustable LED light source, the impact of environmental factors such as light is solved, the contrast between image defects and the background is improved, defect features are enhanced, the problem of missing detection is solved, and the accuracy rate is increased. An algorithm for identifying defects on the basis of multi-information fusion is provided, multi-feature fusion of defects is achieved in multiple viewpoints, and by using the decision tree classification model, the problem that defect features are difficult to accurately identify and classify is solved.

### BRIEF DESCRIPTION OF THE DRAWINGS

The present disclosure may be further understood from the following description in conjunction with the accompanying drawings. The parts in the drawings are not necessarily drawn to scale, but rather the emphasis is placed on illustrating the principles of the embodiments. In the different views, the same reference numerals designate the corresponding portions.

FIG. 1 is a schematic structural diagram of a vision-based enhanced omni-directional defect detection apparatus according to an embodiment of the present disclosure.

FIG. 2 is a schematic diagram of posture adjustment of a vision-based enhanced omni-directional defect detection apparatus according to an embodiment of the present disclosure.

FIG. 3 is a flow diagram of a vision-based enhanced omni-directional defect detection method according to an embodiment of the present disclosure.

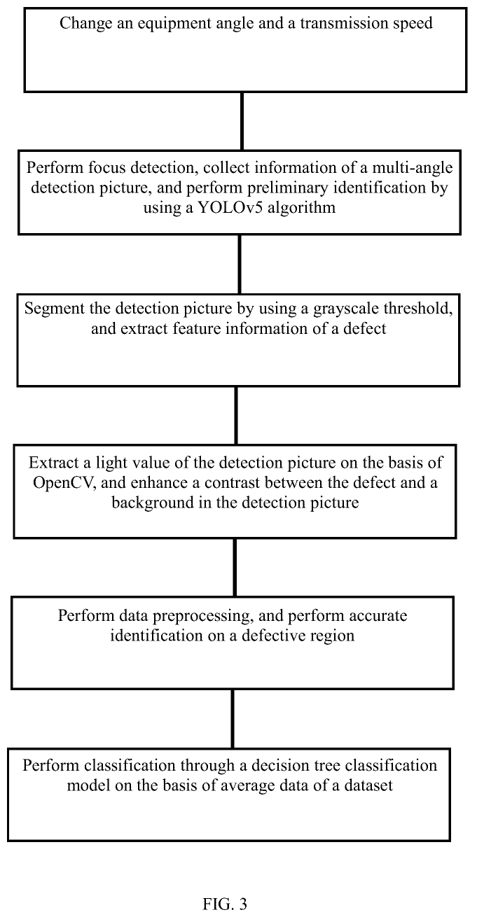

FIG. 4 is a flow diagram of multi-angle acquisition of a detection picture of a vision-based enhanced omni-directional defect detection method according to an embodiment of the present disclosure.

FIG. 5 is a schematic diagram of a decision tree of a vision-based enhanced omni-directional defect detection method according to an embodiment of the present disclosure.

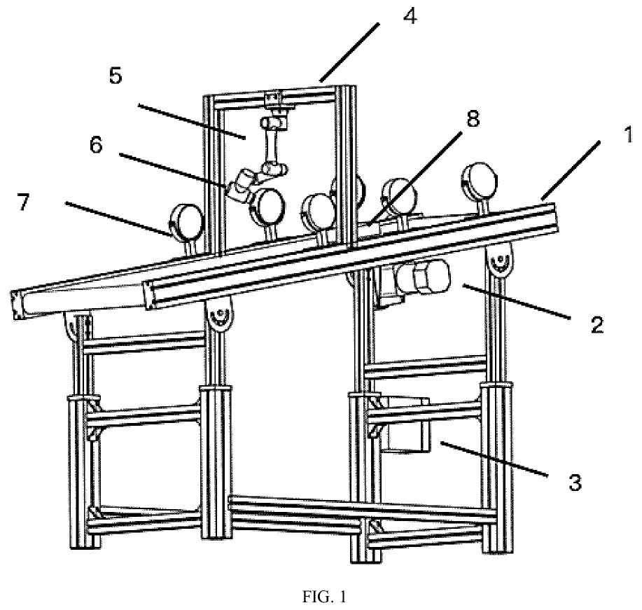

Description of reference numerals in FIG. 1:
1—Conveyor belt; 2—Motor; 3—Gearbox; 4—Lift lever; 5—Six-degree-of-freedom mechanism; 6—CMOS camera; 7—LED light; and 8—Pressure sensor.

### DETAILED DESCRIPTION OF THE EMBODIMENTS

In order to make the objectives, technical solutions and advantages of the present disclosure more clear, the present disclosure is further described in detail below with reference to the embodiments thereof. It is to be understood that the specific implementations described herein are only illustrative of the present disclosure, and are not intended to limit the scope of protection of the present disclosure.

It is to be noted that when an element is described as being “fixed to” another element, it may be directly provided on another element or an intermediate element may be present. When an element is considered as being “connected to” another element, it may be directly connected to another element or an intermediate element may be present at the same time. The terms “vertical”, “horizontal”, “left”, “right”, and similar expressions as used herein are for illustrative purposes only and are not meant to be the exclusive implementation.

Unless otherwise defined, all technical and scientific terms as used herein have the same meaning as commonly understood by those skilled in the art of the present disclosure. The terms as used in the specification of the present disclosure are only for the purpose of describing specific implementations and are not intended to limit the present disclosure. The term “and/or” as used herein includes any and all combinations of one or more of the relevant listed items.

The terms “first” and “second” as used in the present disclosure do not represent a specific number or order, but are merely used for the purpose of distinguishing names.

As shown in FIG. 1, a vision-based enhanced omni-directional defect detection apparatus according to an embodiment of the present disclosure includes a conveyor belt 1, the conveyor belt 1 is connected to a motor 2 and a gearbox 3, a lift lever 4 is disposed on the conveyor belt 1 opposite to one side where the motor 2 is disposed, the lift lever 4 is provided with a six-degree-of-freedom mechanism 5 and a CMOS camera 6, LED lights 7 are disposed along a longitudinal movement direction of the conveyor belt, a pressure sensor 8 is disposed on the conveyor belt 1 opposite to a surface where the LED lights 7 are disposed, and the pressure sensor 8 is connected to a speed regulator.

In one embodiment, the CMOS camera 6 is disposed at an extended portion of the lift lever 4, six LED lights 7 in total are provided, the LED lights are equally distributed longitudinally on two sides of the conveyor belt 1, and the CMOS camera 6 is connected to a tail end of the six-degree-of-freedom mechanism 5.

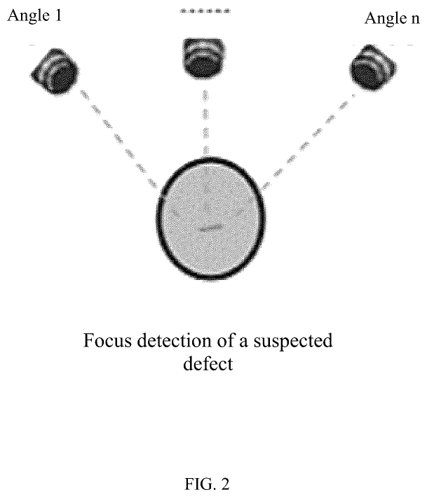

As shown in FIG. 2, a vision-based enhanced omni-directional defect detection method according to an embodiment of the present disclosure includes: Step 1, posture adjustment is performed on equipment, and an equipment angle and a transmission speed are changed. The schematic diagram of posture adjustment is shown in FIG. 2.

Step 2, a source of a suspected defect is searched for, focus detection is performed, and target three-dimensional information is acquired on the basis of monocular multi-view imaging, that is, information of a multi-angle detection picture is collected, and the detection picture is preliminarily identified by using a YOLOv5 defect fast identification technology. In the case where a confidence value is less than 0.6, a defect is a suspected defect, which may or may not be a defect. For further discrimination, a camera changes an angle through a spatial motion change of a six-degree-of-freedom mechanism, so as to acquire pictures of different angles in a suspected defect region taken by the camera from different angles, thereby achieving the purpose of focusing on the same place from multiple angles. Conventional YOLO detection adopts a single fixed angle, which is greatly affected by environmental factors and may cause misidentification. Step 3, in order to further eliminate misidentification, multiple defects of the defect in the identification box are extracted to accurately determine a category, that is, after the multi-angle detection picture is acquired, a defective region within the identification box in the multi-angle detection picture is segmented, and for the defective region, feature information of the defect in the defective region is extracted on the basis of OpenCV, the feature information including area, perimeter, a pixel mean value, and pixel variance information. Step 4, a light value of the detection picture is extracted on the basis of OpenCV, a brightness difference is increased by actively adjusting the intensity of a light source, and a contrast between the defect and a background in the detection picture is enhanced. Extraction of the light value includes: the detection picture is converted from an RGB color space to an HSV space, brightness V values are extracted, and a mean value of the brightness V values is calculated. The detection picture has n non-zero pixels, with a non-zero pixels inside the identification box and b non-zero pixels outside the box, HSV values of the non-zero pixels are (h₁, s₁, v₁), (h₂, s₂, v₂), . . . , (hₙ, sₙ, vₙ) respectively, and a pixel mean V value is calculated as:

$$\overline{v} = \frac{1}{n} \text{?} {v}_{i} ,$$

$$\text{?} \text{indicates text missing or illegible when filed}$$

where v̅ₐ and v̅_{b} are brightness mean values inside the identification box and outside the identification box respectively, and a difference is dₘₐₓ=|v̅ₐ−v̅_{b}|.

Step 5, accurate identification is performed on the defective region. The defect in the defective region is extracted on the basis of OpenCV, data preprocessing is performed firstly, and the image quality is improved through a normalization operation, a normalization formula being

$${x}_{norm} = \frac{x - {x}_{min}}{{x}_{max} - {x}_{min}} ,$$

where X denotes a pixel value of an input image, Xₙₒᵣₘ denotes a pixel value of an output image, Xₘₐₓ denotes a maximum pixel value of the input image, Xₘᵢₙ denotes a minimum pixel value of the input image, and image pixels are adjusted to a range of [0, 1] after normalization;
a defect contour is detected by using Canny edges, then geometric area information S of the defect is acquired by using a function of cv2.contourArea( ) in an OpenCV library, at the same time, geometric perimeter information L of the defect is extracted by using a function of cv2.arcLength( ) in the OpenCV library, a slenderness ratio M and an area occupancy degree N of the defective region are acquired,
the slenderness ratio is obtained by

$$M = \frac{w}{h} ,$$

where h and w are a length value and a width value of the defective rectangular region, and
the area occupancy degree is obtained by

$$N = \frac{S}{w \times h} .$$

Step 6, multi-feature average data of the defect is acquired on the basis of the multi-feature information of the detection picture, the multi-feature average data is used as input, and defect category differentiation is achieved through a decision tree classification model.

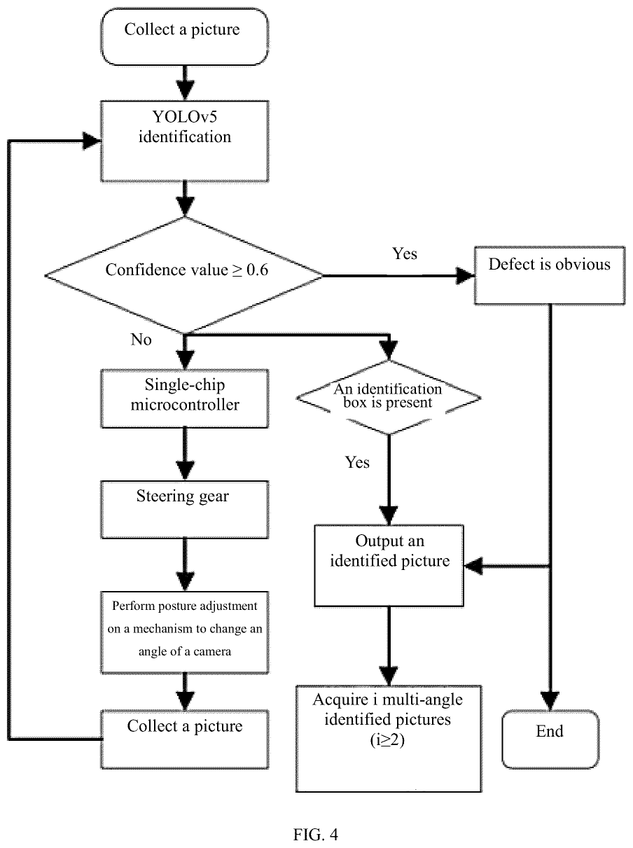

As shown in FIG. 4, in one embodiment, collecting information of a multi-angle detection picture includes: changing the angle of the camera by changing the six-degree-of-freedom mechanism, so as to collect detection picture information at different angles. When the confidence value is less than 0.6, a single-chip microcontroller manipulates a steering gear to adjust the angle of the camera so as to collect the detection picture, and at the same time, in a case where the identification box is present, a plurality of detection pictures are output. When the confidence value is greater than or equal to 0.6, it indicates that the defect is obvious and the operation ends.

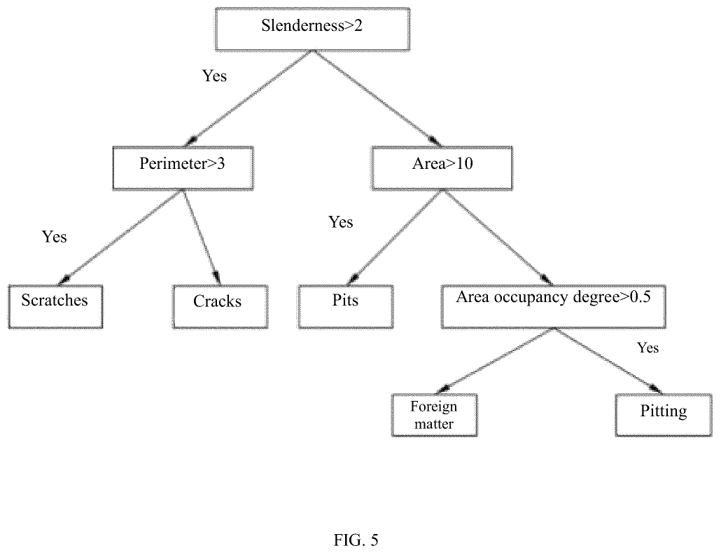

As shown in FIG. 5, in one embodiment, average data obtained on the basis of a detection picture dataset includes an area mean value S̅, a perimeter mean value L̅, a slenderness ratio mean value M̅, and an area occupancy degree mean value N̅, and defect classification is performed through the decision tree classification model. When the perimeter mean value L̅ is greater than 3, a defect is classified to scratches, otherwise to cracks. When the area occupancy degree mean value N̅ is greater than 10, a defect is classified to pits; otherwise, when N̅ is greater than 0.5, a defect is classified to pitting, otherwise to foreign matter.

The various technical features of the above-described embodiments can be combined arbitrarily, and in order to make the description concise, all possible combinations of the various technical features of the above-described embodiments have not been described; however, as long as there is no contradiction in the combinations of these technical features, all of them should be regarded as falling within the scope of the present specification.

The above embodiments express only several implementations of the present disclosure, which are described in a specific and detailed manner, but are not to be construed as a limitation of the scope of protection of the patent of invention. It should be pointed out that, for a person of ordinary skill in the art, several deformations and improvements can be made without departing from the conception of the present disclosure, all of which fall within the scope of protection of the present disclosure. Therefore, the scope of protection of the patent of invention shall be subject to the appended claims.

What is claimed is:

1. A vision-based enhanced omni-directional defect detection apparatus, comprising a conveyor belt, wherein the conveyor belt is connected to a motor and a gearbox, a lift lever is disposed on the conveyor belt opposite to one side where the motor is disposed, the lift lever is provided with a six-degree-of-freedom mechanism and a complementary metal oxide semiconductor (CMOS) camera, a plurality of LED lights are disposed along a longitudinal movement direction of the conveyor belt, a pressure sensor is disposed on the conveyor belt opposite to a surface where the plurality of LED lights are disposed, and the pressure sensor is connected to a speed regulator.

2. The vision-based enhanced omni-directional defect detection apparatus according to claim 1, wherein the CMOS camera is disposed at an extended portion of the lift lever.

3. The vision-based enhanced omni-directional defect detection apparatus according to claim 1, wherein six LED lights in total are provided, and the six LED lights are equally distributed longitudinally on two sides of the conveyor belt.

4. The vision-based enhanced omni-directional defect detection apparatus according to claim 1, wherein the CMOS camera is connected to a tail end of the six-degree-of-freedom mechanism.

5. The vision-based enhanced omni-directional defect detection apparatus according to claim 1, wherein a single-chip microcontroller is connected between the pressure sensor and the motor.

6. A vision-based enhanced omni-directional defect detection method, comprising:
step 1, performing posture adjustment on equipment, and changing an equipment angle and a transmission speed;
step 2, searching for a source of a suspected defect and performing focus detection, comprising collecting information of a multi-angle detection picture, preliminarily identifying the multi-angle detection picture by using a YOLOv5 defect fast identification technology, and in a case where a confidence value is less than 0.6, continuously sending a signal to change the equipment angle and acquiring the multi-angle detection picture;
step 3, after the multi-angle detection picture is acquired, segmenting a defective region within an identification box in the multi-angle detection picture by using a grayscale threshold, and for the defective region, extracting feature information of a defect in the defective region based on OpenCV, wherein the feature information comprises area, perimeter, a pixel mean value, and pixel variance information;
step 4, extracting a light value of the detection picture based on OpenCV, increasing a brightness difference by actively adjusting an intensity of a light source, and enhancing a contrast between the defect and a background in the detection picture, wherein extraction of the light value comprises: converting the detection picture from a red-green-blue (RGB) color space to a hue-saturation-value (HSV) space, extracting brightness V values and calculating a mean value of the brightness V values, and wherein the detection picture has n non-zero pixels, with a non-zero pixels inside the identification box and b non-zero pixels outside the box, HSV values of the non-zero pixels are (h₁, s₁, v₁), (h₂, s₂, v₂), . . . , (hₙ, sₙ, vₙ) respectively, and a pixel mean V value is calculated as:
$$\overline{v} = \frac{1}{n} \text{?} {v}_{i} ,$$
$$\text{?} \text{indicates text missing or illegible when filed}$$
wherein v̅ₐ and v̅_{b} are brightness mean values inside the identification box and outside the identification box respectively, and a difference is dₘₐₓ=|v̅ₐ−v̅_{b}|;
step 5, performing accurate identification on the defective region, wherein the defect in the defective region is extracted based on OpenCV, data preprocessing is performed firstly, and an image quality is improved through a normalization operation, wherein a normalization formula is
$${x}_{norm} = \frac{x - {x}_{min}}{{x}_{max} - {x}_{min}} ,$$
wherein X denotes a pixel value of an input image, Xₙₒᵣₘ denotes a pixel value of an output image, Xₘₐₓ denotes a maximum pixel value of the input image, Xₘᵢₙ denotes a minimum pixel value of the input image, and image pixels are adjusted to a range of [0, 1] after normalization;
a defect contour is detected by using Canny edges, geometric area information S of the defect is acquired by using a function of cv2.contourArea( ) in an OpenCV library, at the same time, geometric perimeter information L of the defect is extracted by using a function of cv2.arcLength( ) in the OpenCV library, a slenderness ratio M and an area occupancy degree N of the defective region are acquired,
the slenderness ratio is obtained by
$$M = \frac{w}{h} ,$$
wherein h and w are a length value and a width value of the defective rectangular region, and
the area occupancy degree is obtained by
$$N = \frac{S}{w \times h} ;$$
and
step 6, acquiring, based on multi-feature information of the detection picture, multi-feature average data of the defect, using the multi-feature average data as input, and achieving defect category differentiation through a decision tree classification model.

7. The vision-based enhanced omni-directional defect detection method according to claim 6, wherein the operation of collecting the information of the multi-angle detection picture comprises: changing an angle of a camera by changing a six-degree-of-freedom mechanism to collect detection picture information at different angles.

8. The vision-based enhanced omni-directional defect detection method according to claim 6, wherein when the confidence value is less than 0.6, a single-chip microcontroller manipulates a steering gear to adjust an angle of a camera to collect the detection picture, and at the same time, in a case where the identification box is present, a plurality of detection pictures are output.

9. The vision-based enhanced omni-directional defect detection method according to claim 6, wherein average data of a detection picture dataset comprises an area mean value S̅, a perimeter mean value L̅, a slenderness ratio mean value M̅, and an area occupancy degree mean value N̅.
